(19) United States
(12) Patent Application Publication
(10) Pub. No.: US 2011/0134208 A1
(43) Pub. Date: Jun. 9, 2011

(54) Panoramic image synthesizer, panoramic image synthesis method, and program

(75) Inventors: Tomotaka Kuraoka, Tokyo (JP); Naomasa Takahashi, Chiba (JP)

(73) Assignee: Sony Corporation, Tokyo (JP)

(21) Appl. No.: 12/927,824

(22) Filed: Nov. 24, 2010

(30) Foreign Application Priority Data
Dec. 3, 2009 (JP) P2009-275377

(51) Int. Cl. H04N 7/00

(52) U.S. Cl. 348/36; 348/E05.024

(57) ABSTRACT

A panoramic image synthesizer includes an image capture unit capturing a plurality of original images that are images taken adjacent to each other having an overlap region and become a part of a panoramic image; a rough synthesis processor extracting a rough process region subjected to processing respectively from two adjacent processed images that are converted to have lower resolution than the original images and calculating a transfer vector between the rough process regions using phase only correlation; an overlap region extraction processor, in a case of further performing precise synthesis, extracting the overlap region between the adjacent images based on the transfer vector; and a precise synthesis processor extracting precise process regions subjected to processing from inside the overlap region of the two processed images and calculating a transfer vector between the precise process regions.

### BACKGROUND OF THE INVENTION

1. Field of the Invention

The present invention relates to a panoramic image synthesizer, a panoramic image synthesis method, and a program.

2. Description of the Related Art

In recent years, digitalization of photographs has been advanced rapidly. With that, manners for enjoying photographs have been varied. For example, opportunities to enjoy using photographs are increased in not only a PC but also various devices, such as a game machine, a television, a digital photo frame, a music player, a mobile phone, and a camera. Since digital data has a nature of being easily replicated and processed, it is also becoming popular for individuals to process images taken by them.

For example, an image synthesizer is currently proposed that synthesize a plurality of images taken by sequentially changing the direction of taking pictures into one panoramic image (for example, Japanese Unexamined Patent Application Publication No. 2006-293851). In view of a current situation in which platforms handling photographs have been varied, it is expected to provide similar image processing functions in these various platforms.

### SUMMARY OF THE INVENTION

However, since the operation is complicated and the volume of computation is large, which demands high throughput, in general panoramic image synthesis software, most of such software runs on a PC (personal computer). Although there are also some devices having a panoramic image synthesis function other than PCs, it is desired in that case to develop respective software corresponding to the computing capability and the resources of a subject device and thus devices with low computing capability have been limited to those of low image editing accuracy.

It is desirable to provide a new and improved panoramic image synthesizer that is able to select accuracy of image synthesis in accordance with the processing environment and usage while reducing the computing volume for process and is possible to flexibly perform desired process in accordance with the demanded accuracy.

According to an embodiment of the present invention, there is provided a panoramic image synthesizer including an image capture unit capturing a plurality of original images that are images taken adjacent to each other having an overlap region and become a part of a panoramic image; a rough synthesis processor extracting a rough process region subjected to processing respectively from two adjacent processed images that are converted to have lower resolution than the original images and calculating a transfer vector between the rough process regions using phase only correlation; an overlap region extraction processor, in a case of further performing precise synthesis, extracting the overlap region between the adjacent images based on the transfer vector; and a precise synthesis processor extracting precise process regions subjected to processing from inside the overlap region of the two processed images and calculating a transfer vector between the precise process regions.

According to such configuration, it is possible to selectively use rough synthesis and precise synthesis in accordance with the computing capability of the panoramic image synthesizer. For example, in a case that a panoramic image synthesizer is lacking in computing capability, only rough synthesis process can be performed according to settings in advance or during processing to reduce the calculation volume. Phase only correlation between rough process regions is used for rough synthesis. This enables to dramatically reduce the calculation volume without degrading the accuracy of synthesis compared with a case of scanning the entire screen by feature point extraction and Lucas-Kanade as in the past.

The rough synthesis processor may calculate the transfer vector and a degree of similarity between the rough process regions and calculate a transfer vector for a combination of the rough process regions in which the degree of similarity becomes a predetermined threshold or more.

The rough synthesis processor may use, in a case that the original images have thumbnail images, the thumbnail images as the processed images.

The rough synthesis processor may decide a size of the processed images and a size of the rough process regions based on a frequency component of the original images.

The rough synthesis processor, in a case of not being able to calculate the transfer vector for the combination of the rough process regions in which the degree of similarity becomes the predetermined threshold or more, may enlarge a resolution of the processed images and perform calculation of a transfer vector for enlarged processed images.

The precise synthesis processor may extract four or more of the precise process regions and calculate transfer vectors between the four or more precise process regions.

The panoramic image synthesizer may further include an image output processor synthesizing and outputting the panoramic image with resolution in accordance with a display device that outputs the panoramic image obtained by synthesizing the original images.

The panoramic image synthesizer may further include a geometric transformation parameter calculation processor calculating a geometric transformation parameter based on the transfer vector calculated in either the rough synthesis processor or the precise synthesis processor.

According to another embodiment of the present invention, there is provided a method of synthesizing a panoramic image of a panoramic image synthesizer having an image capture unit, a rough synthesis processor, an overlap region extraction processor, and a precise synthesis processor, the method includes the steps of image capturing in which the image capture unit captures a plurality of original images that are images taken adjacent to each other having an overlap region and become a part of a panoramic image; rough synthesis processing in which the rough synthesis processor extracts a rough process region subjected to processing respectively from two adjacent processed images that are converted to have lower resolution than the original images and calculates a transfer vector between the rough process regions using phase only correlation; overlap region extraction processing in which the overlap region extraction processor extracts the overlap region between the adjacent images based on the transfer vector; and precise synthesis processing in which the precise synthesis processor extracts precise process regions subjected to processing from inside the overlap region of the two processed images and calculates a transfer vector between the precise process regions.

According to still another embodiment of the present invention, there is provided a program for making a computer to function as a panoramic image synthesizer, includes an image capture unit capturing a plurality of original images that are images taken adjacent to each other having an overlap region and become a part of a panoramic image; a rough synthesis processor extracting a rough process region subjected to processing respectively from two adjacent processed images that are converted to have lower resolution than the original images and calculating a transfer vector between the rough process regions using phase only correlation; an overlap region extraction processor extracting the overlap region between the adjacent images based on the transfer vector; and a precise synthesis processor extracting precise process regions subjected to processing from inside the overlap region of the two processed images and calculating a transfer vector between the precise process regions.

As described above, according to embodiments of the present invention, it is possible to select accuracy of image synthesis in accordance with the processing environment and the usage in a panoramic image synthesizer while reducing a computing volume for panoramic image synthesis process and enables to flexibly perform desired process in accordance with the demanded accuracy.

### BRIEF DESCRIPTION OF THE DRAWINGS

FIG. 1 is a functional block diagram of a panoramic image synthesizer according to an embodiment of the present invention;

FIG. 2 illustrates one example of original images to make a panoramic image by joining them;

FIG. 3 is a flowchart showing a flow of processes of a panoramic image synthesizer according to the embodiment;

FIG. 4 is flowchart showing a flow of rough synthesis process;

FIG. 5 illustrates one example of rough process regions;

FIG. 6 illustrates a calculation volume for processing synthesis in the past;

FIG. 7 illustrates a calculation volume for processing synthesis of the embodiment;

FIG. 8 illustrates an example of superimposing the two images in FIG. 3 based on a transfer vector obtained by rough synthesis process;

FIG. 9 is a flowchart showing a flow of precise synthesis process;

FIG. 10 illustrates one example of precise process regions according to the embodiment;

FIG. 11 illustrates another example of precise process regions according to the embodiment;

FIG. 12 illustrates one example of precise process regions in the past; and

FIG. 13 illustrates the hardware configuration of a panoramic image synthesizer according to the embodiment.

### DESCRIPTION OF THE PREFERRED EMBODIMENTS

A detailed description is given below to a preferred embodiment of the present invention with reference to the attached drawings. In the present specification and drawings, an identical reference numeral is assigned to components having the substantially identical functional configuration to omit repetitive description.

### (Functional Configuration of Panoramic Image Synthesizer)

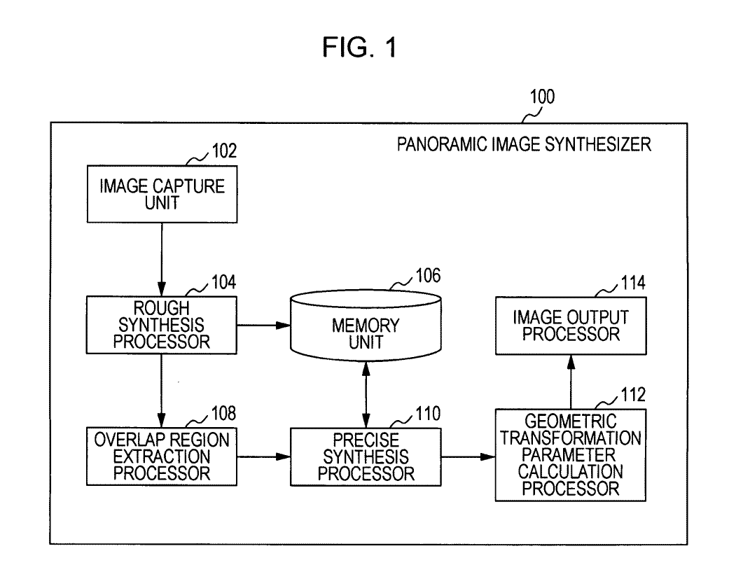

First of all, a description is given to the functional configuration of a panoramic image synthesizer according to an embodiment of the present invention using FIG. 1. FIG. 1 is a functional block diagram to illustrate functions of a panoramic image synthesizer.

A panoramic image synthesizer 100 mainly has an image capture unit 102, a rough synthesis processor 104, a memory unit 106, an overlap region extraction processor 108, a precise synthesis processor 110, a geometric transformation parameter calculation processor 112, and an image output processor 114.

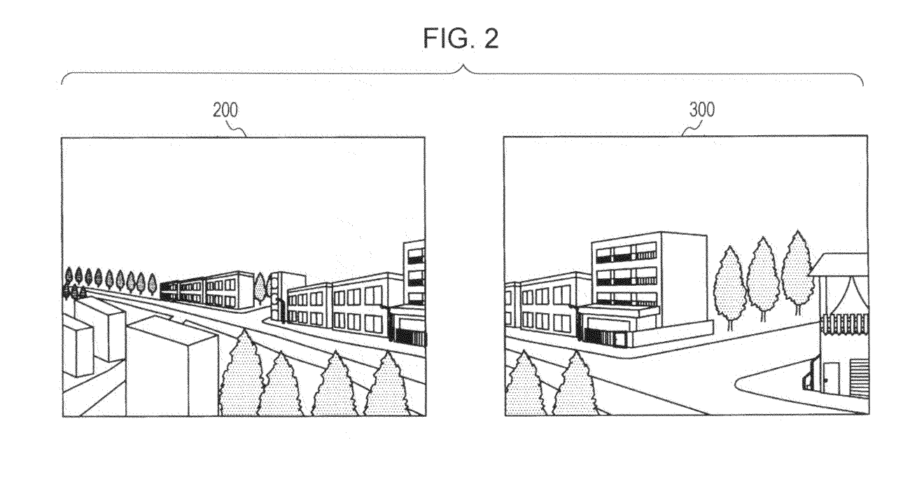

The image capture unit 102 has a function to capture a plurality of original images to create a panoramic image. Here, original images are, as a premise, images adjacent to each other that are taken with an overlap region. An example of such original images is shown in FIG. 2. FIG. 2 illustrates one example of original images to make a panoramic image by joining them. A first original image 200 and a second original image 300 shown in FIG. 2 are images that are taken with an overlap region mutually. The image capture unit 102 may also capture, for example, a plurality of original images selected by a user. The image capture unit 102 then inputs the captured original images to the rough synthesis processor 104.

The rough synthesis processor 104 has a function to obtain a position of joining the original images inputted from the image capture unit 102. The rough synthesis processor 104 obtains processed images, in terms of adjacent two original images, converted to have lower resolution than the resolution of the original images. Alternatively, in a case that the original images have thumbnail images, the rough synthesis processor 104 may also use the thumbnail images as the processed images. Then, in the present embodiment, the rough synthesis processor 104 calculates a position to join two adjacent images as a transfer vector between images using phase only correlation. Detailed process contents of the rough synthesis processor 104 are described later.

The memory unit 106 is a storage device having a storage area. The memory unit 106 can store parameters and the like used for process of the panoramic image synthesizer 100. For example, the memory unit 106 temporarily stores a calculated transfer vector.

The overlap region extraction processor 108 has a function to extract an overlap region between adjacent images based on the transfer vector obtained in the rough synthesis processor 104. The overlap region extraction processor 108 inputs information regarding the extracted overlap region to the precise synthesis processor 110.

The precise synthesis processor 110 has a function to calculate a transfer vector more detailed than rough synthesis using information in the overlap region based on the information regarding the overlap region extracted in the overlap region extraction processor 108. Detailed process contents of the precise synthesis processor 110 are described later.

The geometric transformation parameter calculation processor 112 has a function to calculate a geometric transformation parameter for space projection based on the transfer vector inputted from the precise synthesis processor 110. In a case that the precise synthesis process is omitted, the geometric transformation parameter calculation processor 112 may also perform processes based on the transfer vector inputted from the rough synthesis processor 104. The geometric transformation parameter calculation processor 112 inputs the calculated geometric transformation parameter to the image output processor 114.

The image output processor 114 synthesizes all images into one panoramic image based on the inputted geometric transformation parameter and outputs the panoramically synthesized image. At this time, the image output processor 114 may also calculate optimal resolution for a display device for final output and output the panoramically synthesized image having the resolution in accordance with the display device.

The panoramic image synthesizer 100 according to the present embodiment has functions to carry out two synthesis processes of the rough synthesis processor 104 and the precise synthesis processor 110. The rough synthesis processor 104 obtains a position for synthesis as a transfer vector from state of not at all understanding the position for synthesis between the original images. Then, the overlap region extraction processor 108 extracts an overlap region between the original images based on the transfer vector obtained in the rough synthesis processor 104. The precise synthesis processor 110 calculates a more precise transfer vector than rough synthesis using information in the overlap region between the original images extracted based on the transfer vector obtained by the rough synthesis processor 104.

### (Panoramic Image Synthesis Flow)

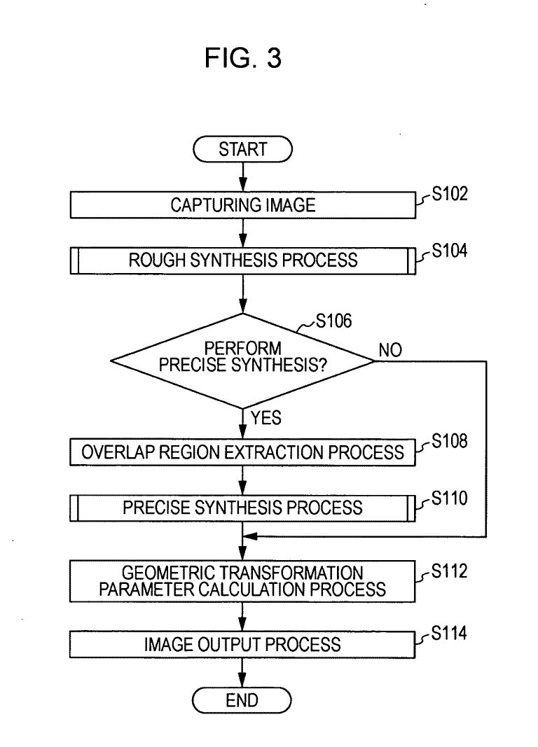

Next, a description is given to a flow of panoramic image synthesis, using FIG. 3, provided in each functional block that has been described above. FIG. 3 is a flowchart showing the entire flow of image synthesis process of the panoramic image synthesizer.

Firstly, the image capture unit 102 captures original images to create a panoramic image (S102). Here, the original images to be captured are, as a premise, images adjacent to each other that are taken with an overlap region as shown in, for example, FIG. 2. For example, the original images may be those taken by a person carrying a camera while sequentially changing the direction of taking pictures. The original images may also be those taken by automatically rotating a camera with a motor for panoramic photography.

### (Rough Synthesis)

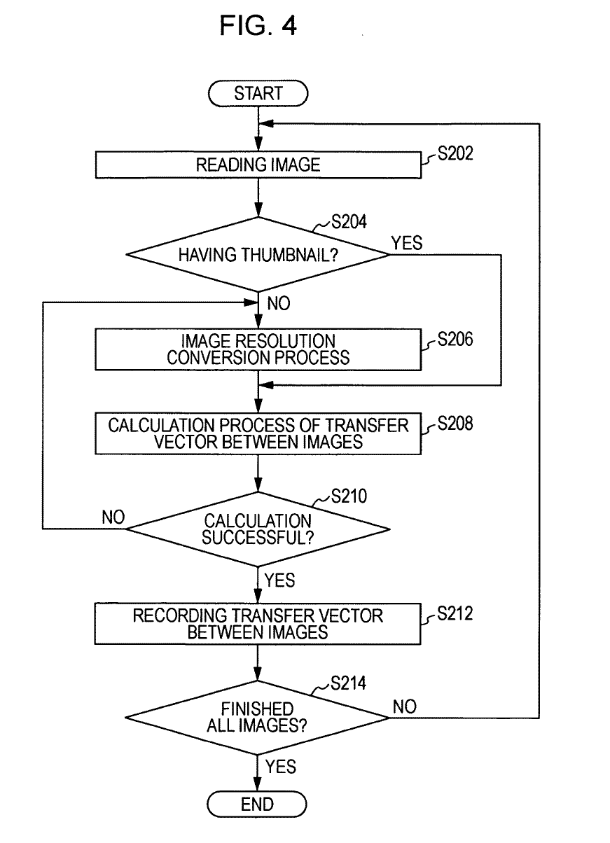

Then, the rough synthesis processor 104 performs rough synthesis process (S104). Here, the detailed contents of rough synthesis process are described using FIG. 4. Firstly, the rough synthesis processor 104 reads two adjacent original images selected out of the original images captured by the image capture unit 102 (S202). Here, the rough synthesis processor 104 may also read images selected by an operation of a user. The rough synthesis processor 104 may also read the original images in the order of, for example, the time and date of being taken.

Then, the rough synthesis processor 104 determines whether or not the read original images have thumbnail images (S204). Here, in a case of determined as the original images read by the rough synthesis processor 104 do not have thumbnail images in the determination at step S204, the rough synthesis processor 104 performs image resolution conversion process to obtain processed images (S206). Here, the image resolution conversion process at step S206 converts while keeping the aspect ratios of the images. For the size of the resolution of the processed images, an internally fixed default value, a value specified by an external file or the like, or a value in accordance with a size of the original images can be used, for example. The size of the processed images is defined to be, for example, 160×120 pixels, which is a size of a general thumbnail image.

On the other hand, in a case of determined as the original images read by the rough synthesis processor 104 have thumbnail images in the determination at step 5204, the rough synthesis processor 104 may omit image resolution conversion process at step S206 and use the thumbnail images as the processed images.

Then, the rough synthesis processor 104 obtains a transfer vector and a degree of similarity (peak value of phase) between the two processed images using phase only correlation (S208). Here, the rough synthesis processor 104 extracts respective blocks subjected to the process from the processed images (referred to below as rough process region) and calculates the transfer vector between the rough process regions.

Here, since phase only correlation uses FFT, the block size of the rough process regions is preferred to be a value expressed as power of two or slightly larger in size than a value expressed as power of two. For example, the rough synthesis processor 104 extracts rough process regions in a size near a value, such as 2, 4, 8, 16, 32, 64, 128, 256, or the like. The size of the rough process regions is decided in accordance with the size of the processed images. It is considered that a practical value as a pixel value used for FFT is preferably from 16 to 128 pixels. In the present embodiment, the rough synthesis processor 104 uses rough process regions in size of 64×64 pixels for processed images in size of 160×120 pixels.

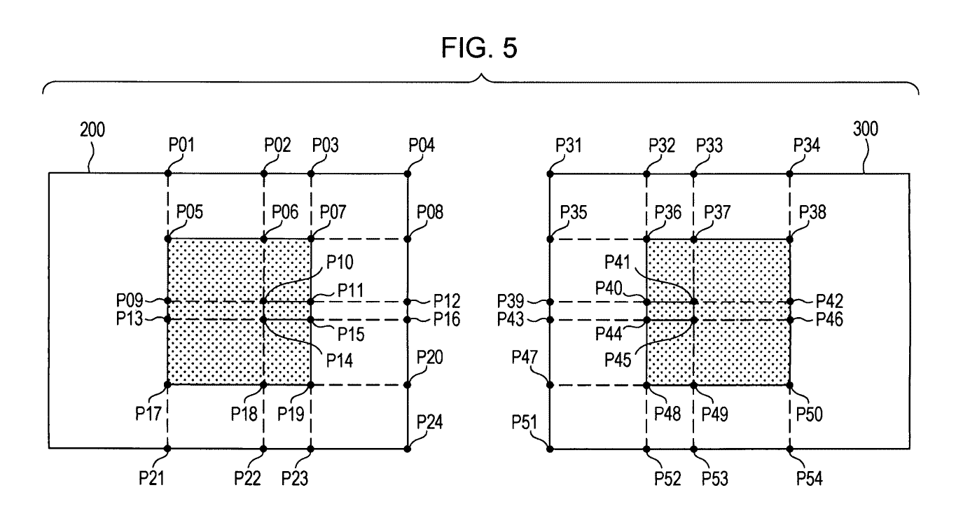

Here, a description is given to rough process regions of processed images 200 and 300 using FIG. 5. FIG. 5 illustrates one example of rough process regions.

In FIG. 5, the processed images 200 and 300 have respective six rough process regions defined therein. In the processed image 200, defined are a first rough process region surrounded by points P01-P13-P15-P03, a second rough process region surrounded by points P02-P14-P16-P04, a third rough process region surrounded by points P05-P17-P19-P07, a fourth rough process region surrounded by points P06-P18-P20-P08, a fifth rough process region surrounded by points P09-P21-P23-P11, and a sixth rough process region surrounded by points P10-P22-P24-P12.

Similarly, in the processed image 300, defined are a seventh rough process region surrounded by points P31-P43-P45-P33, an eighth rough process region surrounded by points P32-P44-P46-P34, a ninth rough process region surrounded by points P35-P47-P49-P37, a tenth rough process region surrounded by points P36-P48-P50-P38, an eleventh rough process region surrounded by points P39-P51-P53-P41, and a twelfth rough process region surrounded by points P40-P52-P54-P42.

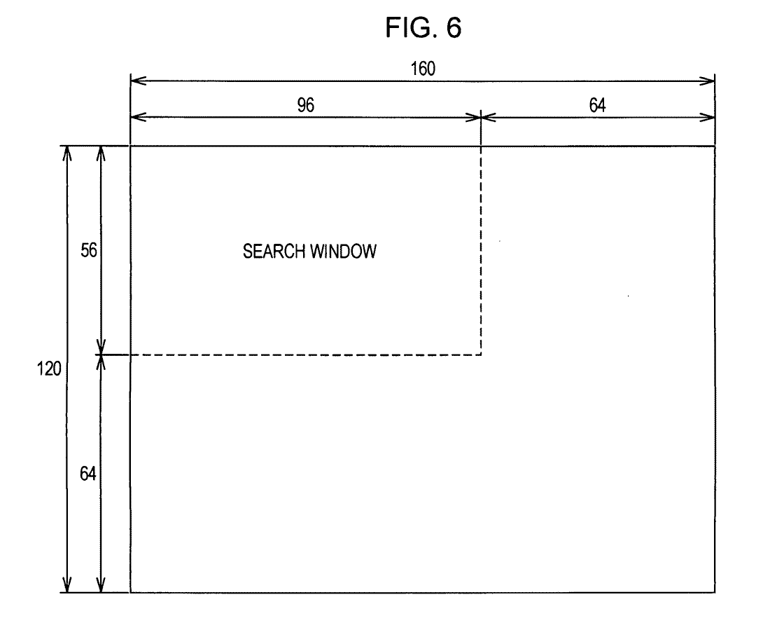

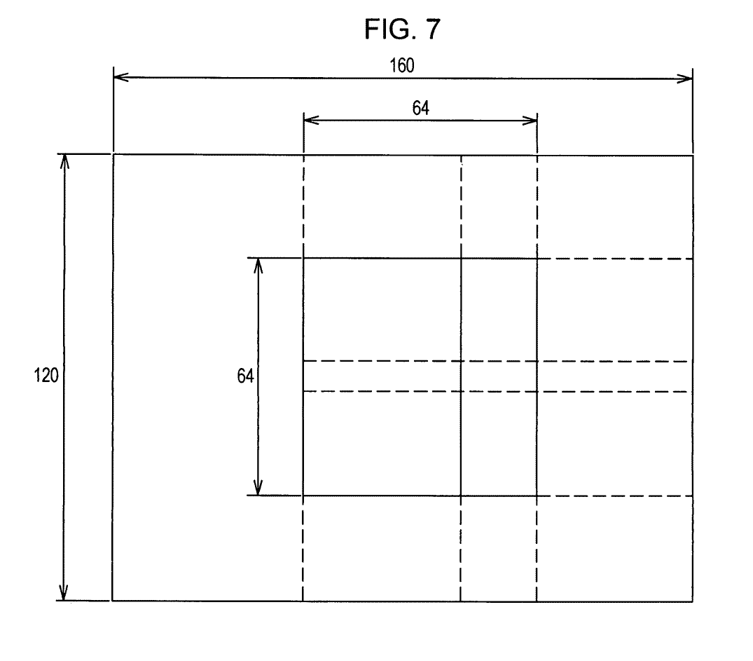

Although various manners to define rough process regions are considered, it is preferred to dispose them to allow efficient calculation of the transfer vector between the two images. In a case of defining six rough process regions for respective images, calculation can be only 36 times even when calculating all combinations, so that the number of calculation can be reduced compared with a method in the past of scanning the entire screen of an image. A description is given to the effect of reduction in computing volume using FIGS. 6 and 7. FIG. 6 illustrates a calculation volume for processing synthesis in the past. FIG. 7 illustrates a calculation volume for processing synthesis of the present embodiment.

FIG. 6 shows a computing volume in a case of performing entire screen scanning of an image of 64×64 pixels for an image of 160×120 pixels. In this case, since computation is desired to be carried out at respective positions shifted 56 times vertically and 96 times horizontally for each pixel, it is expressed as “56×96×PhCo”. On the other hand, a computing volume of the rough synthesis processor according to the present embodiment is expressed as “6×PhCo” in a similar case of defining six rough process regions of 64×64. Accordingly, in this case, an effect of reduction in computing volume of one-896th is expected.

Here, let us go back to FIG. 4 to continue the description regarding rough synthesis process. In transfer vector calculation process at step S208, the rough synthesis processor 104 extracts rough process regions respectively from the first and second processed images 200 and 300 shown in FIG. 5, and phase only correlation between the rough process region extracted from the first processed image 200 (for example, the third rough process region) and the rough process region extracted from the second processed image 300 (for example, the tenth rough process region) is obtained to calculate a phase peak value and a transfer vector.

Phase only correlation used here is a method of finding correlation between images in which only phase components are retrieved (phase only images). Specifically, the rough synthesis processor 104 firstly Fourier transforms two images (for example, here, the third and tenth rough process regions) respectively to obtain phase signals and amplitude signals in a frequency domain. Here, in a phase signal, information of grayscale change, that is, information related to a shape (outline) of a figure is included. On the other hand, in an amplitude signal, intensity of image grayscale, that is, information of brightness is included.

Then, the rough synthesis processor 104 obtains a synthesis signal in which only phase information of the two images are synthesized. By inverse Fourier transformation of the synthesis signal, the phase only correlation is obtained. Then, in the present embodiment, the rough synthesis processor 104 obtains a phase peak value from the phase only correlation, and by inverse transformation of peak coordinate values of the phase, calculates a transfer vector. Here, the phase peak value may also be called as a degree of similarity.

The rough synthesis processor 104 calculates the transfer vector, which is displacement of the image center, using the above method down to the subpixel, and stores the calculated transfer vector and degree of similarity in, for example, the memory unit 106. Then, the rough synthesis processor 104 sequentially changes the subjected combination of the rough process regions to calculate a transfer vector and a degree of similarity for each combination. The rough synthesis processor 104 defines the transfer vector for a combination of the rough process regions with the highest degree of similarity as the transfer vector between the two processed images.

Here, a threshold may also be predetermined for the degree of similarity, and in a case that there is no combination of rough process regions having a degree of similarity of the threshold or more, the resolution of the processed images may also be modified to retry the calculation process of the transfer vector (S210). That is, a case of determined as calculation successful at step S210 is a case that the degree of similarity corresponding to the calculated transfer vector becomes the threshold or more. In a case of determined as calculation failure in the determination at step S210, that is, a case that there is no combination of rough process regions with a degree of similarity of the threshold or more, the rough synthesis processor 104 goes back again to the resolution conversion process at step S206 to increase the resolution of the processed images. For example, the rough synthesis processor 104 enlarges the resolution of the processed images by 1.5-fold and performs calculation of the transfer vector. At this time, the rough synthesis processor 104 adjusts the size of the rough process regions corresponding to the size of the processed images after enlargement.

As the transfer vector that has the degree of similarity of a predetermined threshold or more is calculated by modifying the resolution of the processed images as above, the rough synthesis processor 104 records the calculated transfer vector in the memory unit 106 (S212). Then, the rough synthesis processor 104 determines whether or not calculation of the transfer vector is finished with all the images (S214). Then, since the number of images to be synthesized is two in the present embodiment, the calculation of the transfer vectors for all the images in the determination at step S214 is finished and the rough synthesis process is finished. On the other hand, in a case that there is another image subjected to the process, the procedure goes back to step 5202 to read the subjected image and repeat the processes at steps S202 through S212.

Using FIG. 4, a description has been given above to the details of the rough synthesis process at step S104 in FIG. 3. Here, let us go back to FIG. 3 again to continue the description. As the rough synthesis process is finished, the overlap region extraction processor 108 then determines whether or not to perform precise synthesis process (S106). Such determination may also be carried out by, for example, referring to a predetermined setting file. Then, in a case of determined to perform precise synthesis process, the overlap region extraction processor 108 extracts an overlap region of the images adjacent to each other using the transfer vector calculated in the rough synthesis processor 104 (S108), and then the precise synthesis processor 110 performs precise synthesis process (S110).

### (Precise Synthesis)

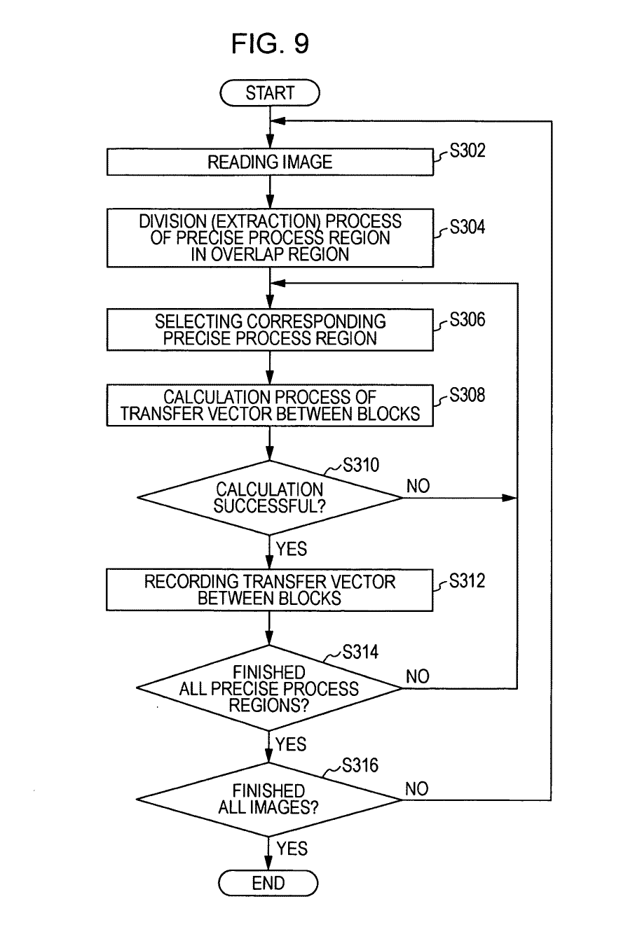

Here, using FIG. 9, details of precise synthesis process is described. FIG. 9 is a flowchart showing a flow of precise synthesis process. Firstly, the precise synthesis processor 110 reads images subjected to the process (S302). In the present embodiment, original images are considered to be used for the processed images.

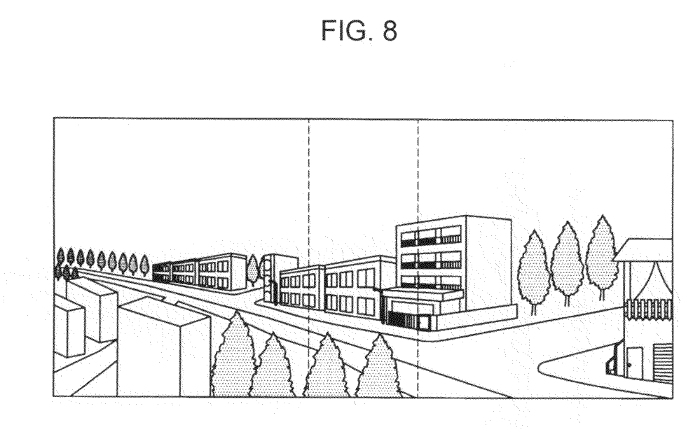

At this time, FIG. 8 is a drawing in which the processed images are superimposed according to the transfer vector obtained in the rough synthesis process at step 5104. In the previous overlap region extraction process, this overlap region of the processed images to each other is extracted.

Therefore, the precise synthesis processor 110 divides inside the overlap region into precise process regions or extracts precise process regions from inside the overlap region (S304). At this time, the precise synthesis processor 110 stores the positions and sizes of blocks of the extracted precise process regions in, for example, the memory unit 106.

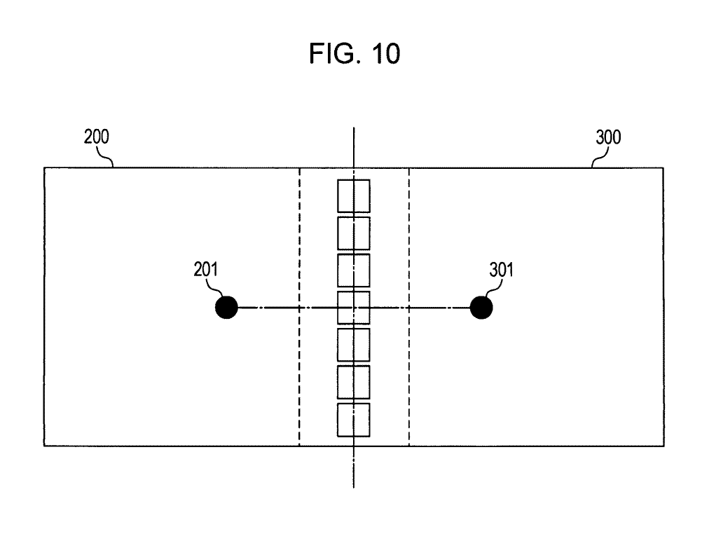

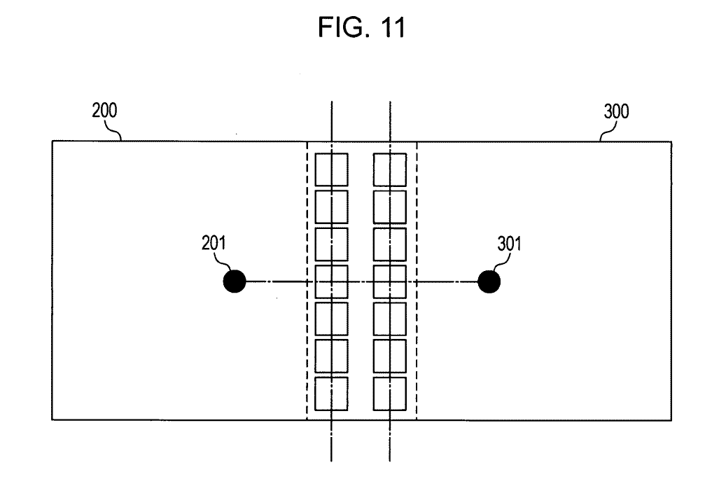

The precise synthesis processor 110 may also extract, for example, precise process regions as shown in FIG. 10 so as to align on a perpendicular bisector of a line connecting a center 201 of the processed image 200 and a center 301 of the processed image 300. In such an example, the precise synthesis processor 110 extracts seven precise process regions. Alternatively, the precise synthesis processor 110 may also extract them on both ends of the overlap region as shown in FIG. 11 so as to align on a line orthogonal to a line connecting the center 201 of the processed image 200 and the center 301 of the processed image 300. In such an example, the precise synthesis processor 110 extracts seven precise process regions on either end, totally 14 regions.

The number of precise process regions is naturally not limited to such examples. They may be extracted three or more in the overlap region. Here, the reason to be three or more is because at least three transfer vectors are desired in geometric transformation parameter calculation process at the next step. As illustrated, the precise process regions are not strictly demanded to be aligned on a straight line and the precise process regions may also be disposed in an uncoordinated fashion within the overlap region.

A method of calculating a geometric transformation parameter from transfer vectors corresponding to three different points in the overlap region of the images to each other is described in, for example, Japanese Unexamined Patent Application Publication No. 2008-117235. In Japanese Unexamined Patent Application Publication No. 2008-117235, the three points are extracted from an overlap region of a pair of images and parameters, such as a lens distortion correction coefficient, a rotation angle, and a tilt angle, are calculated from three transfer vectors. However, the method shown in Japanese Unexamined Patent Application Publication No. 2008-117235 has the following disadvantage.

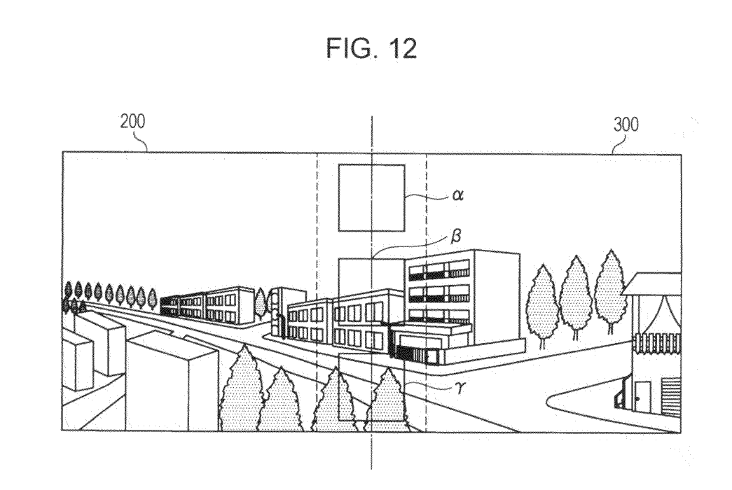

It is easy to obtain a transfer vector between images relatively accurately in a case of, for example, including a large amount of high frequency components in process regions. However, an accurate transfer vector is difficult to be obtained for an image only of low frequency components. For example, images with a large amount of low frequency components may include images of landscape, such as the sky and a sea. That is, as shown in FIG. 12, for example, three points of α, β, γ are supposed to be extracted in the overlap region. FIG. 12 illustrates another example of precise process regions according to the present embodiment. In this case, although there is a high possibility of obtaining accurate transfer vectors in the precise process regions β and γ, there is a very high possibility of not being able to obtain an accurate transfer vector in the precise process region α. Therefore, in the present embodiment, the precise synthesis processor 110 calculates transfer vectors at seven points and select three points of high reliability out of the seven points to input them to the geometric transformation parameter calculation processor 112. Here, the precise synthesis processor 110 may also select three points of high degrees of similarity out of the transfer vectors at the seven points.

Here, let us go back again to FIG. 9 to continue the description. As the precise process regions are defined from inside the overlap region at step S304, the precise synthesis processor 110 then selects a pair of corresponding precise process regions from the processed images 200 and 300 respectively (S306). The precise synthesis processor 110 then calculates transfer vectors in the selected precise process regions (S308). In the present embodiment, similar to the rough synthesis process, the transfer vectors are calculated using phase only correlation. Then, the precise synthesis processor 110 determines whether or not the calculation of the transfer vectors is successful (S310). Such determination may also be made based on, for example, whether or not the degree of similarity is a certain predetermined threshold or more. In a case of successful calculation of the transfer vectors, the precise synthesis processor 110 stores the calculated transfer vectors in the memory unit 106 (S312). Then, the precise synthesis processor 110 determines whether or not the processing for all precise process regions are finished (S314). In a case of a precise synthesis process region subjected to processing still remained, the procedure goes back to step S306 and the precise synthesis processor 110 then selects a precise process region subjected to calculation of the transfer vector. On the other hand, also in a case of determined as the calculation of the transfer vector is failed in the determination at step S310, the procedure goes back to the selection of the precise process regions at step S306 and proceeds to calculation of the transfer vector of the next precise process region.

As the process of transfer vector calculation for all precise process regions is finished in such a manner, the precise synthesis processor 110 then determines whether or not the process is finished with all the images (S316). In a case that there is an image not finished with the process yet, the procedure goes back again to step S302 and the precise synthesis processor 110 then reads two processed images for processing. On the other hand, in a case that the process is finished with all adjacent images, the precise synthesis process is finished.

Here, let us go back again to FIG. 3 to continue the description. As the calculation of transfer vectors by the precise synthesis process at step S110, the geometric transformation parameter calculation processor 112 then calculates a geometric transformation parameter from the transfer vectors to synthesize the plurality of original images into one panoramic image (S112). Alternatively, also in a case of determined not to perform the precise synthesis in the determination at step S106, the geometric transformation parameter calculation processor 112 then calculates a geometric transformation parameter from the transfer vectors. Specifically, an overlap region of the two images is obtained based on the transfer vectors calculated in the precise synthesis processor 110 (in a case of omitting the precise synthesis process, the transfer vectors calculated in the rough synthesis processor) to calculate a geometric transformation parameter from differences between image features and between frequency features of the corresponding overlap regions. The geometric transformation parameter obtained here is a parameter for image synthesis by space projection, such as a lens distortion correction coefficient, a rotation angle, or a tilt angle, for example. The calculation of the geometric transformation parameter is described in, for example, Japanese Unexamined Patent Application Publication No. 2008-117235.

Then, as the calculation of the geometric transformation parameter is finished, the image output processor 114 creates and outputs one panoramic image in which the plurality of original images are projected in a cylindrical coordinate space for synthesis based on the calculated transfer vectors and geometric transformation parameter (S114). At this time, the image output processor 114 may also output an image of a resolution in accordance with a display device for final output. Due to such configuration, even when some correction errors are left, it is possible to display so as not to distinguish the errors in a case of viewed by a user.

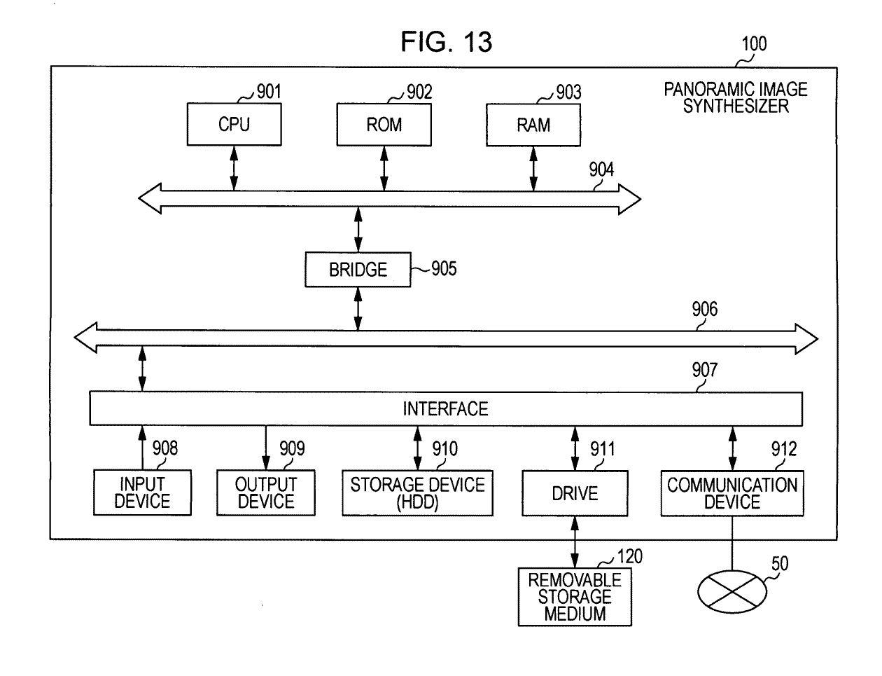

FIG. 13 shows one example of the hardware configuration of the panoramic image synthesizer 100 according to the present embodiment described above. FIG. 13 illustrates one example of the hardware configuration of a panoramic image synthesizer according to the present embodiment.

The panoramic image synthesizer 100 mainly has a CPU (central processing unit) 901, a ROM (read only memory) 902, a RAM (random access memory) 903, a host bus 904, a bridge 905, an external bus 906, an interface 907, an input device 908, an output device 909, a storage device (HDD) 910, a drive 911, and a communication device 912.

The CPU 901 functions as an arithmetic processing unit and a control device and controls overall behaviors in the panoramic image synthesizer 100 according to various programs. The CPU 901 may also be a microprocessor. The ROM 902 stores programs and computing parameters used by the CPU 901. The RAM 903 primarily stores programs used in performance of the CPU 901 and parameters appropriately changing in the performance. They are connected to each other by the host bus 904 configured with the CPU bus and the like.

The host bus 904 is connected to the external bus 906, such as a PCI (peripheral component interconnect/interface) bus, via the bridge 905. The host bus 904, the bridge 905, and the external bus 906 are not strictly desired to be separately configured and these functions may also be implemented in one bus.

The input device 908 is configured with an input mechanism for a user to input information, such as a mouse, a keyboard, a touch screen, a button, a microphone, a switch, and a lever, for example, an input control circuit to generate an input signal based on a user input and output to the CPU 901, and the like. A user of the panoramic image synthesizer 100 can input various data and direct processing behaviors to the panoramic image synthesizer 100 by operating the input device 908.

The output device 909 is configured with a display device, such as a CRT (cathode ray tube) display device, an LCD (liquid crystal display) device, an OLED (organic light emitting display) device, and a lamp, for example, and an audio output device, such as a speaker and a headphone. The output device 909 outputs, for example, replayed contents. Specifically, the display device displays a variety of information, such as replayed visual data, with texts or images. In the meanwhile, the audio output device outputs replayed audio data or the like by converting into audio.

The storage device 910 is a device for data storage configured as one example of a storage unit of the panoramic image synthesizer 100 according to the present embodiment, and can include a storage medium, a recording device to record data in the storage medium, a reading device to read data from the storage medium, a removal device to remove data recorded in the storage medium, and the like. The storage device 910 may also include an HDD (hard disk drive), for example. The storage device 910 drives a hard disk and stores programs and a variety of data performed by the CPU 901.

The drive 911 is a reader/writer for a storage medium and is built in the panoramic image synthesizer 100 or connected externally. The drive 911 reads information recorded in a mounted removable storage medium 120, such as a magnetic disk, an optical disk, a magnetoptical disk, or a semiconductor memory, to output to the RAM 903.

The communication device 912 is a communication interface configured with a communication device or the like to connect to, for example, a communication network 50. The communication device 912 may also be a wireless LAN (local area network) compatible communication device, a wireless USB compatible communication device, or a wired communication device to carry out wired communication. The communication device 912 transmits and receives a variety of data, such as setting information, in between with a client 20 via the communication network 50.

### (Example of Effect)

As described above, the panoramic image synthesizer 100 according to the present embodiment has two-step processing synthesis units of the rough synthesis processor 104 and the precise synthesis processor 110. By separating the synthesis process into two steps in such a manner, even when a program in which a processing procedure of the panoramic image synthesizer 100 is described is applied to a device not having a high processing capability, such as a game machine, a television, a digital photo frame, a music player, a mobile phone, and a camera, for example, it has the configuration that can perform function(s) only corresponding to the environment, such as the computing capability and the resources, of a applying device (for example, only the rough synthesis process), so that it is possible to apply without recompiling the program to match the environment of the device.

By analyzing the frequency components of the processed images and extracting the rough process regions in a suitable size particularly in the rough synthesis process as above, it is possible to reduce the calculation volume without degrading the accuracy. That is, the reduction in calculation volume leads to shortening of the time period for processing.

The panoramic image synthesizer 100 according to the present embodiment has the configuration that can recursively calculate a parameter using an image with even more enlarged resolution in a case of not being able to calculate a highly reliable parameter from the image with the firstly set resolution and in a case of having allowance in the computing capability and the resources. This enables to perform panoramic synthesis with accuracy in accordance with the environment and the usage.

Further, the panoramic image synthesizer 100 has the configuration that can also use thumbnail images in Exif information of the image files as the processed images instead of creating the processed images by converting the resolution. Accordingly, in a case that the image files have thumbnail images, it is possible to omit the time for processing the resolution conversion of the images.

The image output processor 114 adjusts the resolution of the images to be outputted in accordance with the display device for final output or the like. This enables not to distinguish correction errors, even in a case that the image after synthesis has the correction errors, in the output result viewed by a user.

Since the phase only correlation used for the rough synthesis finds correlation by retrieving only the phase components of the images, that is, information related to the outlines of images, it has an advantage of being able to calculate the transfer vectors without affected by an exposure difference between images.

Further, in the precise synthesis process, by calculating transfer vectors in four or more points, it becomes possible to calculate reliable parameters even in a case of an image having a part with a large amount of low frequency components and with less change (for example, an image of the sky and a sea).

The panoramic image synthesizer 100 automatically performs synthesis into a panoramic image without a user input of a parameter, such as a position of view and a projection method, for example, during the process. Accordingly, it is possible to synthesize into a panoramic image easily without stress even in a device not having sufficient operability, such as a game machine, a television, a digital photo frame, a music player, a mobile phone, and a camera, for example. Not depending on knowledge of a user, anyone can obtain same synthesis results.

Although a detailed description has been given above to a preferred embodiment of the present invention with reference to the attached drawings, embodiments of the present invention are not limited to such example. It is apparent that those having common knowledge in the technical field of embodiments of the present invention can think of various modifications or corrections within the scope of the technical ideas according to embodiments of the present invention, and it should be understood that they also belong to the technical scope of embodiments of the present invention.

For example, although the original images are used as the processed images in the precise synthesis in the embodiment above, embodiments of the present invention are not limited to such an example. For example, images more reduced than the original images may also be used as the processed images corresponding to the computing capability or the like of the panoramic image synthesizer. However, in a case of using reduced processed images, the images desirably have resolution higher than the processed images in the rough synthesis process.

Further, images from which noises are eliminated by noise filtering the original images may also be used as the processed images to be used for the precise synthesis. This enhances a possibility of calculating more accurate transfer vectors and a geometric transformation parameter.

In addition, although the phase only correlation is used for the precise synthesis in the embodiment above, for example, embodiments of the present invention are not limited to such an example. For example, the method may also be feature point extraction, Lucas-Kanade, or the like as understood as a method in the past.

In addition, although the description has been given to a case of two original images in the embodiment above, for example, embodiments of the present invention are not limited to such an example. It may also synthesize three or more original images into one panoramic image. It may also synthesize into, not limited to a landscape panoramic image, a portrait panoramic image. Further, images may also be joined both vertically and horizontally.

The steps described in the flowcharts in this specification include not only the processes carried out chronologically following the described sequences but also processes performed in parallel or separately not strictly processed chronologically. It should be naturally understood that even the steps processed chronologically, depending on a case, can be modified in the sequence appropriately.

The present application contains subject matter related to that disclosed in Japanese Priority Patent Application JP 2009-275377 filed in the Japan Patent Office on Dec. 3, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A panoramic image synthesizer comprising:
an image capture unit capturing a plurality of original images that are images taken adjacent to each other having an overlap region and become a part of a panoramic image;
a rough synthesis processor extracting a rough process region subjected to processing respectively from two adjacent processed images that are converted to have lower resolution than the original images and calculating a transfer vector between the rough process regions using phase only correlation;
an overlap region extraction processor, in a case of further performing precise synthesis, extracting the overlap region between the adjacent images based on the transfer vector; and
a precise synthesis processor extracting precise process regions subjected to processing from inside the overlap region of the two processed images and calculating a transfer vector between the precise process regions.

2. The panoramic image synthesizer according to claim 1, wherein the rough synthesis processor calculates the transfer vector and a degree of similarity between the rough process regions and calculates a transfer vector for a combination of the rough process regions in which the degree of similarity becomes a predetermined threshold or more.

3. The panoramic image synthesizer according to any of claim 1 or 2, wherein the rough synthesis processor uses, in a case that the original images have thumbnail images, the thumbnail images as the processed images.

4. The panoramic image synthesizer according to any one of claims 1 through 3, wherein the rough synthesis processor decides a size of the processed images and a size of the rough process regions based on a frequency component of the original images.

5. The panoramic image synthesizer according to any one of claims 2 through 4, wherein the rough synthesis processor, in a case of not being able to calculate the transfer vector for the combination of the rough process regions in which the degree of similarity becomes the predetermined threshold or more, enlarges a resolution of the processed images and performs calculation of a transfer vector for enlarged processed images.

6. The panoramic image synthesizer according to any one of claims 1 through 5, wherein the precise synthesis processor extracts four or more of the precise process regions and calculates transfer vectors between the four or more precise process regions.

7. The panoramic image synthesizer according to claim 1, further comprising an image output processor synthesizing and outputting the panoramic image with resolution in accordance with a display device that outputs the panoramic image obtained by synthesizing the original images.

8. The panoramic image synthesizer according to any one of claims 1 through 7, further comprising a geometric transformation parameter calculation processor calculating a geometric transformation parameter based on the transfer vector calculated in either the rough synthesis processor or the precise synthesis processor.

9. A method of synthesizing a panoramic image of a panoramic image synthesizer having an image capture unit, a rough synthesis processor, an overlap region extraction processor, and a precise synthesis processor, the method comprising the steps of:
image capturing in which the image capture unit captures a plurality of original images that are images taken adjacent to each other having an overlap region and become a part of a panoramic image;
rough synthesis processing in which the rough synthesis processor extracts a rough process region subjected to processing respectively from two adjacent processed images that are converted to have lower resolution than the original images and calculates a transfer vector between the rough process regions using phase only correlation;
overlap region extraction processing in which the overlap region extraction processor extracts the overlap region between the adjacent images based on the transfer vector; and
precise synthesis processing in which the precise synthesis processor extracts precise process regions subjected to processing from inside the overlap region of the two processed images and calculates a transfer vector between the precise process regions.

10. A program for making a computer to function as a panoramic image synthesizer, comprising:
an image capture unit capturing a plurality of original images that are images taken adjacent to each other having an overlap region and become a part of a panoramic image;
a rough synthesis processor extracting a rough process region subjected to processing respectively from two adjacent processed images that are converted to have lower resolution than the original images and calculating a transfer vector between the rough process regions using phase only correlation;
an overlap region extraction processor extracting the overlap region between the adjacent images based on the transfer vector; and
a precise synthesis processor extracting precise process regions subjected to processing from inside the overlap region of the two processed images and calculating a transfer vector between the precise process regions.
